(19) United States
(12) Patent Application Publication
(10) Pub. No.: US 2026/0040190 A1
(43) Pub. Date: Feb. 5, 2026

(54) FEATURE-DRIVEN NETWORK ACCESS CONTROL

(71) Applicant: Fraunhofer-Gesellschaft zur Förderung der angewandten Forschung e.V., München (DE)

(72) Inventors: Nazanin VATANIAN, Erlangen (DE); Gustavo Wagner Oliveira Da Costa, Erlangen (DE); Geordie George, Erlangen (DE); Elke Roth-Mandutz, Erlangen (DE)

(21) Appl. No.: 19/300,280

(22) Filed: Aug. 14, 2025

Related U.S. Application Data
(63) Continuation of application No. PCT/EP2024/053769, filed on Feb. 14, 2024.

(30) Foreign Application Priority Data
Feb. 15, 2023 (EP) 23156929.4

(51) Int. Cl. H04W 48/02; H04W 8/24; H04W 48/16; H04W 52/02

(52) U.S. Cl. CPC H04W 48/02; H04W 8/24; H04W 48/16; H04W 52/0212

(57) ABSTRACT

A First transceiver, especially transceiver of a user equipment, UE, is configured to receive a signal comprising one or more enhanced fields carrying an information for access control based upon feature support and/or feature activation, wherein the transceiver is configured to control its own access to the cell dependent on the one or more enhanced fields.

### CROSS-REFERENCE TO RELATED APPLICATIONS

This application is a continuation of copending International Application No. PCT/EP2024/053769, filed Feb. 14, 2024, which is incorporated herein by reference in its entirety, and additionally claims priority from European Application No. EP 23156929.4, filed Feb. 15, 2023, which is also incorporated herein by reference in its entirety.

Embodiments of the present invention refer to a first transceiver, especially transceiver of a user equipment, and to a second transceiver, especially transceiver of a base station. Further embodiments refer to a corresponding method and computer program. An embodiment referred to Network Access Adaptation for NES Techniques Feature-Driven Network Access Control. Other embodiments refer to load balancing.

### BACKGROUND OF THE INVENTION

FIG. 6 is a schematic representation of an example of a terrestrial wireless network 100 including, as is shown in FIG. 6(a), the core network 102 and one or more radio access networks RAN₁, RAN₂, . . . RAN_{N}. FIG. 6(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 6(b) shows an exemplary view of five cells, however, the RANₙ may include more or less such cells, and RAN, may also include only one base station. FIG. 6(b) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 6(b) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 6(b) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 6(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 6 may be a heterogeneous network having distinct overlaid networks, e.g., a network of macro cells with each macro cell including a macro base station, like base station gNB₁ to gNB₅, and a network of small cell base stations, not shown in FIG. 6, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 6, for example in accordance with the LTE-Advanced Pro standard or the 5G or NR, new radio, standard.

In mobile communication networks, for example in a network like that described above with reference to FIG. 6, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 6. This is referred to as an “in-coverage” scenario. Another scenario is referred to as an “out-of-coverage” scenario. It is noted that “out-of-coverage” does not mean that the two UEs are not within one of the cells depicted in FIG. 6, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 7 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 6. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 8 is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 8 which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 7, in addition to the NR mode 1 or LTE mode 3 UEs 202, 204 also NR mode 2 or LTE mode 4 UEs 206, 208, 210 are present. In addition, FIG. 8, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210

Although FIG. 7 and FIG. 8 illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

### SUMMARY

An embodiment may have a first transceiver, e.g. a transceiver of a user equipment, UE configured
to receive a signal comprising one or more enhanced fields carrying an information for access control based upon feature support of one or more features or feature activation of one or more features, and
   wherein the first transceiver is configured to control its own access to a cell dependent on the one or more enhanced fields;
   wherein the information for access control is carried by master information block, MIB, or system information block, SIB;
   wherein if the one or more features are not supported or de-activated by the UE, the transceiver considers the cell as barred;
   wherein the one or more features comprise Network Energy Saving, NES, feature or Network Energy Saving, NES, capability;
   wherein the transceiver is configured to transmit in response to one or more enhanced fields including an information on NES capability or a request an information element indicating a NES capability.

Another embodiment may have a second transceiver, e.g. a transceiver of a base station, BS, being configured to transmit a signal within a cell, the signal comprising one or more enhanced fields carrying an information for access control based upon feature support of one or more features or feature activation of one or more features, and

wherein the second transceiver is configured to control access to the cell dependent on the one or more enhanced fields;
wherein the information for access control is carried by master information block, MIB, or system information block, SIB;
wherein if the one or more feature are not supported or de-activated by the UE, the transceiver considers the cell as barred;
wherein the one or more feature comprise Network Energy Saving, NES, feature or Network Energy Saving, NES, capability;
wherein the transceiver is configured to transmit in response to one or more enhanced fields including an information on NES capability or a request an information element indicating NES capability.

Another embodiment may have a communication network having at least one cell, wherein the communication network includes a first inventive transceiver and a second inventive transceiver.

Another embodiment may have a UE including a second inventive transceiver wherein the second transceiver is configured to prefer a cell if a number of features supported by the UE is high and to deprioritize a cell where the number of features supported by the UE is low; or to reselect a cell is barred as response to a list of features or IDs of the features supported by the cell.

Another embodiment may have a BS or network control comprising a first inventive transceiver and being further configured for load balancing within a cell, being configured for:
supporting load balancing by broadcasting a list of IDs of the features supported by the cell so as to force the UE to reselect if one or more features are not supported; or supporting load balancing by broadcasting respective IDs of the features to be
supported by the UE or of the features supported by the cell so that the UE is enabled to prioritize cells where there is a higher number of matches and deprioritize cells where there is lower number of matches or no matches; or
performing load balancing in a network where different priorities are assigned to different frequencies, especially absolute priority 3 and 5 and wherein load balancing is managed by reverting the frequency priority order; or
performing load balancing in a network having at least one cell wherein load balancing is performed by transmitting a cell magnet bit which indicates whether this cell is preferred by new UEs or UEs having certain feature capability; or
performing load balancing in a cell by choosing features to be supported based on a number or percentage of the UEs in said cell supporting said features; or
performing load balancing in a cell by choosing features to be supported based on a number or percentage of the UEs in said cell supporting said features, wherein the number or the percentage is determined by the cell by polling or based on receipt of information element indicating UE capabilities; or
performing load balancing by coordinating features to be supported by neighboring cells.

According to another embodiment, a method for operating a second transceiver may have the steps of:
transmitting a signal within a cell, the signal comprising one or more enhanced fields carrying an information for access control based upon feature support of one or more features or feature activation of one or more features, and
controlling access to the cell dependent on the one or more enhanced fields;
wherein the information for access control is carried by master information block, MIB, or system information block, SIB;
wherein if the one or more feature are not supported or de-activated by the UE, the transceiver considers the cell as barred;
wherein the one or more feature comprise Network Energy Saving, NES, feature or Network Energy Saving, NES, capability;
wherein the transceiver is configured to transmit in response to one or more enhanced fields including an information on NES capability or a request an information element indicating NES capability.

According to another embodiment, a method for operating first transceiver may have the steps of: receiving a signal comprising one or more enhanced fields carrying an information for access control based upon feature support of one or more features or feature activation of one or more features, and
controlling its own access to a cell dependent on the one or more enhanced fields;
wherein the information for access control is carried by master information block, MIB, or system information block, SIB;

wherein if the one or more feature are not supported or de-activated by the UE, the transceiver considers the cell as barred;

wherein the one or more feature comprise Network Energy Saving, NES, feature or Network Energy Saving, NES, capability;

wherein the transceiver is configured to transmit in response to one or more enhanced fields including an information on NES capability or a request an information element indicating NES capability.

Another embodiment may have a non-transitory digital storage medium having a computer program stored thereon to perform any of said inventive methods when said computer program is run by a computer.

Below, background of embodiments of the present invention will be discussed, where in it is clear, that the discussion of the background belongs to the invention.

New features, like Network Energy Saving (NES) techniques shall be introduced in Rel-18 and future releases of 5G NR. In order that the network can implement highly optimized NES techniques it may be needed that the network controls the access and load in each cell. Some of the techniques (yet to be standardized) may involve support from UEs. Legacy UEs will not be able to assist the network and may not even be able to operate in a cell implementing NES techniques. Therefore, as part of NES implementation there is a need to control which UEs access which cell at each point in time.

In fact, the NES work item description in RP-223540 presents an objective to prevent legacy UEs to access cells adopting Rel-18 techniques. As described in TR 38.864, a solution may rely on the existing cell barring technique. This technique which is used to prevent the UEs from camping on the cells, and as part of new introduced mechanism may now be used to filter out the legacy traffic from a certain cell. With this technique the NES cells can bar the legacy UEs but let the NES capable UEs to camp on the cell. This allows the gNBs to optimize energy savings by using a NES technique which may not be supported by the legacy UEs.

While some NES techniques were selected for standardization in Rel-18, most likely further enhancements and techniques will follow on subsequent releases. Then, the problem is more generic than just blocking Rel-15/16/17 from a Rel-18 cell. For the foreseeable future, there will be different levels of NES techniques and new features needing support from network and UEs. With the new NES techniques coming up in the future, the cell may need to differentiate between the UEs supporting a very specific technique and bar the UEs who may not support that technique. At the same time the total time and complexity for a UE to determine if a cell is barred should be kept within bounds. Otherwise, the UEs will spend a lot of time and battery to find suitable cells. This invention solves these problems by providing a solution to fine-control different type of UEs and whether they can camp on a cell or not.

After the cell barring is applied, the UEs which are barred should leave the cell to camp on a neighboring cell where they are not barred, i.e., legacy cells. This causes a load imbalance. As an example, just after Rel-18 NES features are implemented, the number of UEs supporting these features will be close to zero and the share of legacy UEs will be close to 100%. And yet, the network may need to direct legacy UEs to legacy cells only and NES UEs to NES cells only. As the share of legacy UEs will shrink over time, the optimal network strategy will change and eventually NES UEs also should be directed to legacy cells, which will be there just to support a few legacy UEs. Therefore, a complete solution to the problem described above includes also means to guide different UE types to a certain cell type to keep a balanced load, which is also covered by this invention.

In summary, this invention establishes a framework to optimize the access to a 5G NR network and future standards which may dynamically configure and re-configure cell support to NES-aware UEs and legacy UEs. More generally, the problem is to control the access based on whether the UE supports some features or not. While the motivation has been NES, the solution is also applicable to other features which are not NES features.

According to conventional approaches in 5G NR, the network can bar the UEs by using the cellBarred or cell reservation fields in MIB/SIB. To prevent the legacy UEs from camping on the NES cells the network can set the cellBared in the MIB to ‘barred’. As mentioned in R2-2211666, the NES capable UEs that do not have backward compatibility problem can ignore the cellBarred bit and camp on the NES cells. As the network should be able to bar the NES capable users as well as the legacy UEs, another bit in SIB can be considered for this purpose. In any case, irrespective of the cellBarred field being set to ‘barred’ or ‘not barred’ in MIB, the NES capable UEs will ignore it and consider the additional bit in the SIB applicable to them.

Another option would be to introduce a new bit as suggested in R2-2212116 and use it in combination with the CellReservedForOtherUse/CellReservedForFutureUse fields to bar the different group of UEs capable or not capable of NPN (Non-Public Networks) and NES. Even though using the above structures can lead to barring the different type of UEs, it will need a redesign in the future to accommodate upcoming new techniques. If not designed for forward compatibility the solution could become overly complex over time, as the cell would need to bar all the UEs with different levels of support of the techniques being used by the cell.

Another issue to consider is that if there are a lot of legacy UEs in the cells, barring them and making them camp on the legacy cells can lead to load imbalance. In this case, as mentioned in R2-2211681, it would be beneficial that the NES UEs prioritize the NES cells to help load balancing. But even this method needs a redesign every time a new NES technique is introduced.

Embodiments of the present invention provide a first transceiver, e.g. of a user equipment, UE, configured to receive a signal comprising one or more enhanced fields carrying an information for access control based upon feature support and/or feature activation, wherein the first transceiver is configured to control its own access to the cell dependent on the one or more enhanced fields.

The enhanced field of the signal may, for example, be a field in the signal which is additionally available when compared to the comparable signal as used before. For example, starting from the current specification TS38.331 V17.3.0 (cf. reference 7) said signal, e.g., the MIB or SIB signal, is enhanced so as to include the additional field.

Further embodiments provide a second transceiver, e.g. of a base station, BS, being configured to transmit a signal within a cell, The signal comprising one or more enhanced fields carrying an information for access control based upon feature support and/or feature activation, and wherein the second transceiver is configured to control access (e.g. of the first transceiver) to the cell dependent on the one or more enhanced fields.

Expressed in other words this means that the second transceiver, e.g., the base station transceiver, may use an additional field to perform access control. This means that the access of another transceiver, e.g., the first transceiver, e.g. a user equipment, is controlled by use of the one or more enhanced fields.

Further embodiments provide UE comprising a transceiver or UE transceiver which is configured to prefer a cell if a number of features supported by the UE is high and to deprioritize a cell where the number of features supported by the UE is low; and/or to reselect a cell is barred as response to a list of features or IDs of the features supported by the cell.

Further embodiments provide a BS or network control configured for load balancing within a cell, being configured for:
supporting load balancing by broadcasting a list of IDs of the features supported by the cell so as to force the UE to reselect if one or more features are not supported; or
supporting load balancing by broadcasting respective IDs of the features to be supported by the UE or of the features supported by the cell so that the UE is enabled to prioritize cells where there is a higher number of matches (between features supported by UE and the cell) and deprioritize cells where there is lower number of matches or no matches; or
performing load balancing in a network where different priorities are assigned to different frequencies (e.g. absolute priority 3 and 5) and wherein load balancing is managed by reverting the frequency priority order; or

performing load balancing in a network having at least one cell wherein load balancing is performed by transmitting a cell magnet bit which indicates whether this cell is preferred by new UEs or UEs having certain feature capability; or
performing load balancing in a cell by choosing features to be supported based on a number or percentage of the UEs in said cell supporting said features; or
performing load balancing in a cell by choosing features to be supported based on a number or percentage of the UEs in said cell supporting said features, wherein the number or the percentage is determined by the cell by polling or based on receipt of information element indicating UE capabilities; or
performing load balancing by coordinating features to be supported by neighboring cells.

Embodiments of the invention provide a beneficial concept for adapting the network access and suggest different ways for cell barring and how to deal with the load balancing problem after the barring is happened.

Another embodiment refers to a communication system having a first and a second transceiver. For example, the two transceivers may communicate with each other or may be configured to communicate with each other. Here, the second transceiver performs the access control using the one or more enhanced fields. For example, the first transceiver searches for access or gains access to the cell.

Below, optional aspect of the present invention will be discussed.

According to embodiments, an information for access control can be carried by master information block (MIB) and/or system information block (SIB), MIB/SIB, or carried as Wifi beacon; alternatively, the one or more enhanced fields are included in at least one of the following:
on MIB
on a MIB extension.
on SIB-1;
on other SIB(s).

According to embodiments, the transceiver (e.g. of the UE) considers the cell as low priority if the indicated feature is not supported by the UE.

According to embodiments, the transceiver (e.g. of the UE) considers the cell as barred if the indicated feature is not supported by the UE.

According to embodiments, the enhanced fields comprise IDs or list of IDs; and/or wherein the enhanced fields comprise support levels; and/or wherein the enhanced fields are defined as 1 bit per feature; note the more enhanced fields correspond to UE capabilities.

According to embodiments, the one or more enhanced fields indicate one or more features as barring features where if the feature is not supported by the UE, the UE shall consider the cell as barred, and/or as implying de-prioritization features where if the feature is not supported by the UE, the cell shall be considered with low priority for access.

According to embodiments, accessing using limited access comprises access having low priority and/or having exceptions and/or comprising only being able to access if high priority or critical service is to be used.

According to embodiments, the transceiver (e.g. of the UE) is configured to transmit an information element indicating a feature capability or NES capability; note the one or more enhanced fields may include feature IDs or a list of feature IDs assigned to features to be supported by the BS and/or UE; alternatively, the feature IDs or a list of feature IDs comprise one of:
White-list of features which imply barring;
Black-list of features which imply barring;
White-list of features which imply de-prioritization;
Black-list of features which imply de-prioritization.

According to embodiments, the transceiver (e.g. of the UE) is configured to transmit in response to one or more enhanced fields including an information on a feature and/or NES capability or a request an information element indicating a respective feature and/or NES capability. Here, the information element may be transmitted using one or more enhanced fields or as a mapping between UE capabilities and one or more enhanced fields.

According to embodiments, the information element comprises one of: .
Full or no support of NES techniques; or.
An indication of the supported or not supported NES techniques;
RAN release specific indication of the supported NES techniques;
whether the framework is supported or not;
how quickly the UE can adapt if the added field(s) are changed.

According to embodiments, the transceiver (e.g. of the UE) is configured to use neighboring cell if cell is barred; alternatively the transceiver may be configured to reselect a cell is barred as response to a list of IDs of the features supported by the cell.

According to embodiments, the transceiver (e.g. of the UE) is configured wherein a plurality of the one or more enhanced fields are used independent from each other so that each feature or group of features is enabled to be activated or de-activated independently from other features.

According to embodiments, the one or more enhanced fields include an information of support level for different network releases.

According to embodiments, the one or more enhanced fields comprise multiple barring bits or a master barring switch.

According to embodiments, the transceiver (e.g. of the UE) is configured to receive an extension bit, like MIB extension, and if the UE does not support the extension shall consider the cell as barred.

According to embodiments, the transceiver (e.g. of the UE) is configured to prefer a cell where the one or more enhanced fields indicated the respective one or more features of the UE are supported/needed.

According to embodiments, the transceiver is configured to prefer a cell where the one or more enhanced fields indicated the respective one or more features of the UE are supported/needed and wherein the preferring is performed by comparing respective IDs of the features supported by the UE and IDs of the features supported by the cell so as to prioritize cells where there is a higher number of matches (e.g. between features supported by UE and the cell) and deprioritizing cells where there is lower number of matches or no matches.

According to embodiments, wherein an information for access control can be carried by one or more of the following:
system information block (SIB), for example SIB-1 or any other SIB;
master information block (MIB) or master information block (MIB) comprising an extension or the one or more enhanced fields;
any other option;
Wi-Fi beacon;
as to any combination of the above options or any other kind of signaling.

According to embodiments, the one or more enhanced fields indicate one or more features to be supported by the UE to access the cell and/or implying barring and/or features which imply de-prioritization.

According to embodiments, the BS is configured to provide access UEs in a limited manner and/or de-prioritized if the UE does not support features which imply de-prioritization.

According to embodiments, access in a limited manner comprises access having low priority and/or low performance and/or exceptions (e.g. on the uac-BarringInfo element on SIB-1).

According to embodiments, the cell provided by the BS comprises a first sub-cell for UEs supporting features which imply de-prioritization and a second sub-cell for UEs supporting features which imply de-prioritization.

According to embodiments, the one or more enhanced fields carrying an information on one of the following:
One or more features used e.g. feature ID, feature list, any other form to NES technique; or
UE capability (requirements);
UE capability mapped to a feature ID; or
RAN release/support level.

According to embodiments, a plurality of the one or more enhanced fields are used independent from each other so that each feature or group of features is enabled to be activated or de-activated independently from other features.

According to embodiments, the one or more enhanced fields include feature IDs or a list of feature IDs assigned to features to be supported by the BS and/or UE; and/or
wherein the feature IDs or a list of feature IDs comprise one of:
White-list of features which imply barring;
Black-list of features which imply barring;
White-list of features which imply de-prioritization;
Black-list of features which imply de-prioritization.

According to embodiments, the one or more enhanced fields include an information of support level for different network releases.

According to embodiments, the one or more enhanced fields comprise multiple barring bits or a master barring switch.

According to embodiments, the signal is sent using PBSCH.

According to embodiments, the at least one field is the last MIB bit used as first part for access control; and/or wherein the one or more enhanced fields are used as second part.

According to embodiments, MIB bits are used for the one or more enhanced fields which are not used according to Rel-17 or which are not used according to Rel-17 for access control.

According to embodiments, the transceiver (e.g. of the BS) is configured for broadcasting a list of IDs of the features supported the cell and/or broadcasting a list of IDs of the features supported by the cell before barring the access.

According to embodiments, the BS is configured for performing load balancing by one of the following mechanisms:
supporting load balancing by broadcasting a list of IDs of the features supported by the cell so as to force the UE to reselect if one or more features are not supported; or
supporting load balancing by broadcasting respective IDs of the features to be supported by the UE or of the features supported by the cell so that the UE is enabled to prioritize cells where there is a higher number of matches (e.g. between features supported by UE and the cell) and deprioritize cells where there is lower number of matches or no matches; or
performing load balancing in a network where different priorities are assigned to different frequencies (e.g. absolute priority 3 and 5) and wherein load balancing is managed by reverting the frequency priority order; or
performing load balancing in a network having at least one cell wherein load balancing is performed by transmitting a cell magnet bit which indicates whether this cell is preferred by new UEs or UEs having certain feature capability; or
performing load balancing in a cell by choosing features to be supported based on a number or percentage of the UEs in said cell supporting said features; or
performing load balancing in a cell by choosing features to be supported based on a number or percentage of the UEs in said cell supporting said features, wherein the number or the percentage is determined by the cell by polling or based on receipt of information element indicating UE capabilities; or
performing load balancing by coordinating features to be supported by neighboring cells.

An embodiment provides a method for operating a second transceiver, e.g. of a BS, base station, comprising:
transmitting a signal within a cell, The signal comprising one or more enhanced fields carrying an information for access control based upon feature support and/or feature activation,
controlling access (e.g. of the second or another transceiver) to the cell dependent on the one or more enhanced fields.

An embodiment provides method for operating first transceiver, e.g. of an user equipment, UE, comprising:
receiving a signal comprising one or more enhanced fields carrying an information for access control based upon feature support and/or feature activation, and
controlling its own access to the cell dependent on the one or more enhanced fields.

An embodiment provides a method for operating a second transceiver, e.g. of a BS, base station, comprising: preferring a cell if a number of features supported by the UE is high and to deprioritize a cell where the number of features supported by the UE is low; and/or reselecting a cell is barred as response to a list of features or IDs of the features supported by the cell.

An embodiment provides a method for operating a first transceiver, e.g. of an user equipment, UE, comprising:
load balancing within a cell, being configured for:
   supporting load balancing by broadcasting a list of IDs of the features supported by the cell so as to force the UE to reselect if one or more features are not supported; or
   supporting load balancing by broadcasting respective IDs of the features to be supported by the UE or of the features supported by the cell so that the UE is enabled to prioritize cells where there is a higher number of matches (e.g. (between features supported by UE and the cell) and deprioritize cells where there is lower number of matches or no matches; or
   performing load balancing in a network where different priorities are assigned to different frequencies (e.g. absolute priority 3 and 5) and wherein load balancing is managed by reverting the frequency priority order; or
   performing load balancing in a network having at least one cell wherein load balancing is performed by transmitting a cell magnet bit which indicates whether this cell is preferred by new UEs or UEs having certain feature capability; or
   performing load balancing in a cell by choosing features to be supported based on a number or percentage of the UEs in said cell supporting said features; or
   performing load balancing in a cell by choosing features to be supported based on a number or percentage of the UEs in said cell supporting said features, wherein the number or the percentage is determined by the cell by polling or based on receipt of information element indicating UE capabilities; or
   performing load balancing by coordinating features to be supported by neighboring cells.

According to embodiments, the methods may be computer implemented.

### BRIEF DESCRIPTION OF THE DRAWINGS

Embodiments of the present invention will be detailed subsequently referring to the appended drawings, in which:

FIG. 1 is a block diagram illustrating-when a certain technique is applied (feature is activated)—how the UEs supporting that technique will still camp on the same cell according to an embodiment;

FIG. 2a/b are illustrations of two overlapping/neighboring cells to discuss embodiments; note when one of the cells apply a NES technique the UEs supporting that technique may be attracted to that cell and UEs not supporting the technique may re-select to the other cell.

FIG. 3 is an illustration of two cells coordinated to select different feature set in order to serve the maximum number of users according to an embodiment.

FIG. 4a/b are block diagrams illustrating—when adapting a cell that may consider the percentage of UE support—the selection among different options according to an embodiment; note the UEs may be polled to inform their capabilities.

FIG. 5a/b are schematic tables to be discussed in the context of embodiments.

FIG. 6a/b, 7, 8 are schematic representations for discussing communication entities and scenarios according to embodiments.

FIG. 9 is a schematic block diagram from illustrating computer products according to an embodiment.

### DETAILED DESCRIPTION OF THE INVENTION

Embodiments discussed in general in above description will be discussed in detail in the following:

The solution according to an embodiment is based on preventing legacy UEs via the existing mechanisms (e.g. cellBarred) and adding one or more new fields which allow to fine-control whether UEs supporting a certain set of features (e.g. NES techniques) should be able to access the cell or not. The information provided in a single cell may be applicable to a single cell or a group of cells, for example all cells on a certain frequency layer.

The new field(s) may be according to embodiments implemented in different ways, e.g.:
Directly on MIB in a new system (e.g. 6G) or a new release
On a MIB extension (5G NR only has 1 bit left on MIB—so any fields larger than 1 bit has to be on a MIB extension).
On SIB-1
On other SIB(s)

In general, the new field(s) indicates according to embodiments which features are currently used at the cell, so that a UE can decide, either:
If the UE supports all activated features the UE can access the cell
If the UE does not support some or all of the activated features, it does not access the cell (i.e. consider the cell as barred)

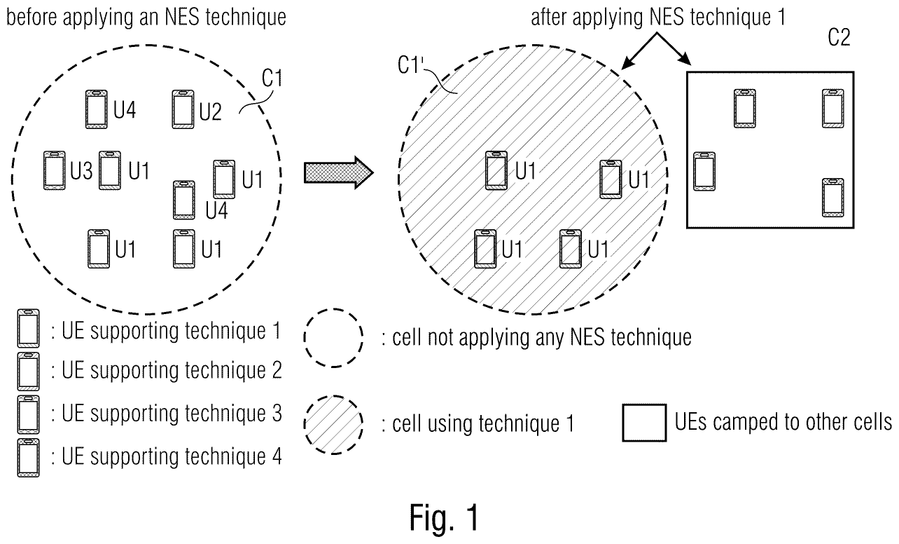

FIG. 1 illustrates the principle of performing access control. On the left-hand side a cell C1 is shown where four different UE types U1 to U4 are available. This cell C1 illustrates the status before applying an NES technique. The four UEs U1 to U4 support different techniques, i.e., have the capability for using different features and/or having different features activated.

Starting from the activated and/or supported features the UEs U1 to U4 can access the cell C1′ after applying NES technique 1. Starting from this only the UE U1 is allowed to access the cell C1′, wherein the other UEs, U2, U3 and U4, are camped to other cells C2. Expressed in other words, this means that in case any technique (1), i.e., a certain technique, is applied (future is activated) and just the UEs UE1 supporting that technique will still camp on the same cell C1′. Other UEs UE2 to UE4, which are not supporting the applied technique, may need to reselect a new cell C2.

Note that the formulation says “currently” because the value of the field may vary dynamically as the network adapts the cell operation.

As described above, the access according to a first embodiment is not possible if even a single active feature is not supported by the UE. This may be too restrictive for some use cases. There are features (e.g. NES techniques or other features) which can only be operated if the UE supports them. In this case it is clear that the cell should be considered barred if the UE does not support such feature. However, there are also features which still have some degree of legacy support, albeit with e.g. reduced performance. In this case it could be useful to group the features into 2 groups:
“Features which imply Barring”—if such features are activated and the UE does not support even one of these features it should consider the cell as barred (first embodiment)
“Features which imply De-prioritization”—if such features are activated the UE should search for another cell but this cell could still be considered with low (or lowest) priority according to a second embodiment.

In case the distinction is made, each of these group of features can be signaled independently using one of the embodiments described below. As examples further elaborated on the following subsections, the new field(s) may comprise of 1 separate or combined indication of either
A feature e.g. feature ID, feature list, any other form to NES technique or.
UE capability (which may be mapped to a feature ID) or.
RAN release.

Besides indication in new field(s) in MIB/SIB, one or multiple new UE capabilities could be added to the existing UE capabilities indicating, whether a UE is supporting specific features, e.g. NES techniques.

For certain combinations of features and traffic, there could be exceptions to barring. For example, if the cell is using a NES feature which still could support legacy UEs, with reduced performance, it may make sense to allow only emergency calls. These exceptions may be based e.g. on the uac-BarringInfo element on SIB-1.

### Independent Indication Per Feature or Group of Features

In this embodiment each feature or group of features can be activated or de-activated independently from other features by using independent indications. This indication in one or multiple field(s) may be transmitted on SIB-1 or any other SIB independent of the indication on the MIB or as an extension of the indication (e.g. cell barred) on the MIB.

For example, 1 bit may indicate whether one specific feature is activated or not, e.g. one specific NES technique. Alternatively, one bit or field may indicate a combination (e.g. multiple) of NES techniques. Multiple NES techniques may refer to new techniques supported by a RAN release, e.g. all NES techniques specified (optional and/or mandatory) in Rel-18 in technical specifications (TS).

This bit indicates if the feature is currently in use in that cell. If all features in use are supported by the UE then the UE can access the cell. Otherwise, it should consider the cell barred and search for another suitable cell. As described in above section, depending on the feature(s), e.g. NES techniques, used in the cell, the UE may be able to (temporarily) use the cell, although one or more features (e.g. NES techniques) are not supported.

### Feature ID and Feature List

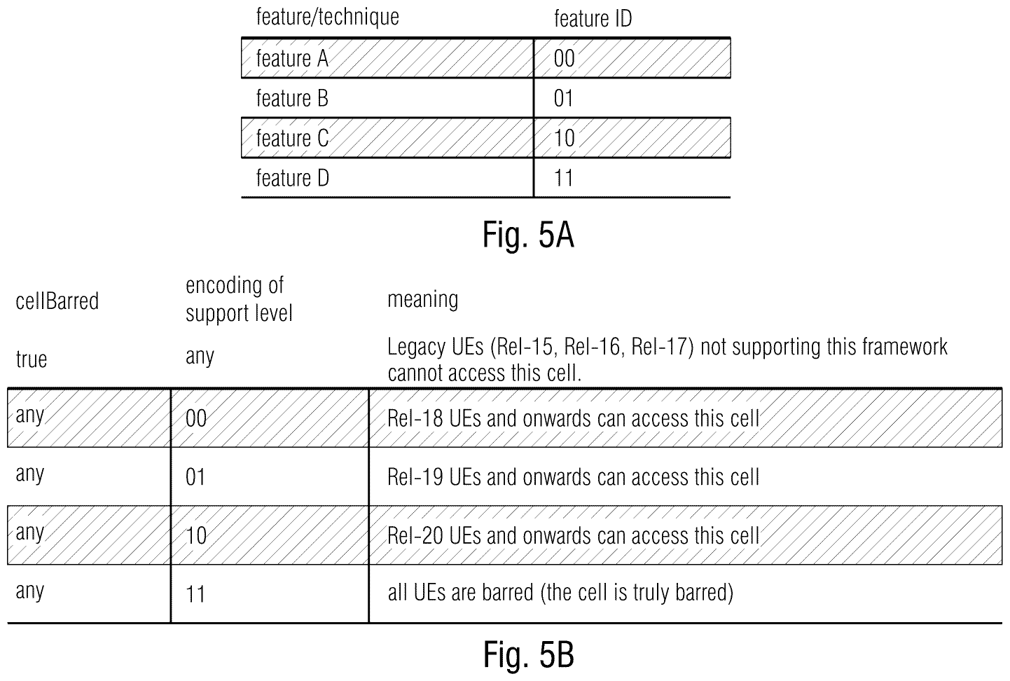

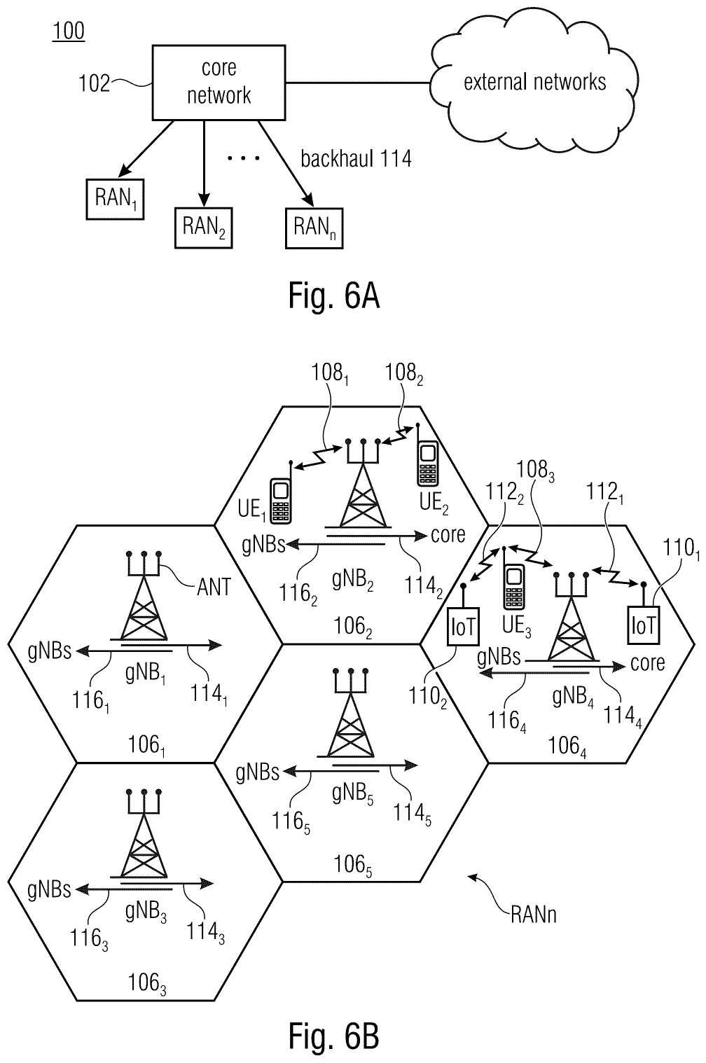

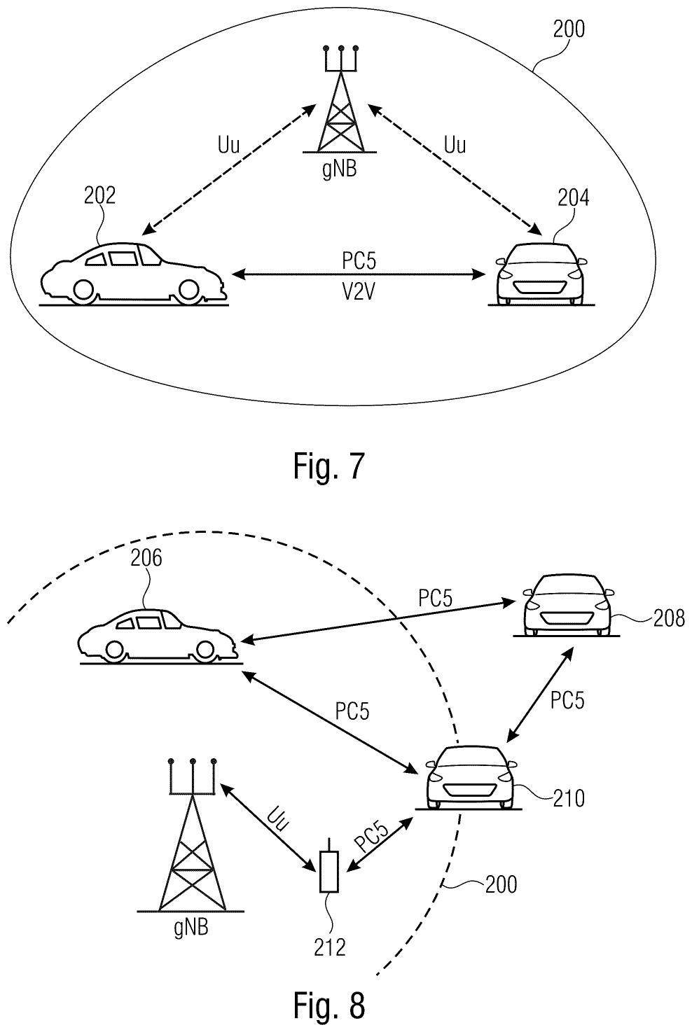

In this solution/embodiment instead of grouping the UEs to two group of NES UEs and legacy UEs, the UEs are grouped based on the feature IDs they can support. If instead of a bit, n bits are used to bar the UEs it would give 2\hat{ }n combination options. Which means 2\hat{ }n features can be addressed with these IDs. The table of FIG. 5a shows an example ID allocation to the features in case n equals to 4.

For example, different features may be identified using a feature ID as illustrated by FIG. 5a. These different features, feature A to feature D, also referred to as techniques, may form the basis for grouping UEs to certain groups of NES UEs. Based on the group the barring or camping on the cell may be done as illustrated with respect to FIG. 1.

Instead of grouping UEs to different NES groups, wherein the groups differ from each other in that the different UEs support different futures, a so-called support level may be used.

For example, the support double (cf. level 0 to 11) may be connected with the release which is supported by the respective UE as illustrated by FIG. 5b.

In this case, as illustrated in FIG. 1, each feature has an ID. This ID should be known by both the cell and the UEs. The idea would be for the cell to broadcast the list of IDs, which is pointing to the features that the cell will be using, and all UEs which are not supporting any of these features would technically be barred. Thus, only the group of UEs supporting any of these features would be allowed to camp in the cell. The list may be implemented as a white-list or a black-list. In the white-list approach the cell signals the features which can join this cell. If a UE does not implement such features, it should search for another cell. In the black-list approach the cell signals a list of features which are currently not acceptable at this cell. If such features are applicable to the UE (e.g. Redcap), then the UE cannot join this cell. It may also be possible that both a white-list and a black-list are provided. Note that combining a white-list or a black-list with barring and de-prioritization 4 lists are possible:
White-list of features which imply barring
Black-list of features which imply barring
White-list of features which imply de-prioritization.
Black-list of features which imply de-prioritization

An embodiment may contain one, all or any combination of these lists thereof.

As an example, as depicted in the FIG. 1, when a cell switches to using a NES technique (or couple of techniques) the UEs which support these technique(s) will camp on the cell (the UEs inside the circle) and the UEs which do not support these technique(s) will be barred and should move to the other cells to camp on them (UEs depicted on the margin of circle).

### Support Level Indication

In some embodiments the new field(s) may indicate a support level. In addition to that, one particular encoding may be used for barring all UEs which apply this framework. This may be particularly useful to group features based on a release. In the case of NES, as features are expected to be introduced e.g. on Rel-18, Rel-19 and Rel-20, 2 bits could be used to represent all support levels. An example is shown by FIG. 5b.

FIG. 5a shows a table where an assignment of different support levels or techniques or features or group of techniques from 0 to 11 is assigned to different releases.

Naturally, the exact encoding can be varied. For example 00 could mean all UEs are barred instead. Also, the encoding may be decided when it is only strictly needed. For example, if the NES features are defined on Rel-18, Rel-19, and Rel-21 (but not 20), then there is no need to use an encoded word for Rel-20 support level. That can be used for Rel-21 instead. The codeword corresponding to all UEs being barred can also be used for extension re-using the technique of section “MIB extension with barring”. In that way, extensions would be possible.

### Master Barring Switch for Legacy Support

In order to prevent all legacy UEs to enter a NES cell, multiple barring bits need to be/mac be (according to embodiments) activated, e.g.: cellBarred set to “barred”, cellBarredRedCap1Rx set to “barred” and “cellBarredRedCap2Rx” set to “barred”. Similarly for the fields CellReservedForOtherUse and CellReservedForFutureUse, which NPN capability from cells and UEs. Then, for example just combining these old capabilities with NES cells would duplicate such bits (a cellBarred-NES, cellBarredRedCap1Rx-NES, cellBarredRedCap2Rx-NES, CellReservedForOtherUse-NES, CellReservedForFutureUse-NES, etc). Instead of having all these new extra bits, this can be done with less bits by having a master barring switch which indicates whether legacy barring bits are currently being set to “barred” because of NES or it is really working on the legacy barring way. If the barring is because of NES, the framework of this invention can be used instead to accomplish a variety of scenarios with much less bits (e.g. using the approach described on sections “Feature ID and Feature List” or “Support level indication”)

The description of the field could be legacyBarringOrNewBarring-r18.

If set to “legacy” the fields cellBarred, cellBarredRedCap1Rx, cellBarredRedCap2Rx, CellReservedForOtherUse and CellReservedForFutureUse are evaluated according to TS 38.304. If set to “new” those fields are ignored and the new barring framework is used.

### MIB Extension With Barring

The solution according to this embodiment would be most naturally implemented in the MIB rather than in the RMSI (SIB-1). In fact, the original design in 5G NR (Rel-15) was to have the cellBarred bit in the MIB. There are a number of reasons for that. The PBSCH (where MIB is sent) can be decoded every time the SSB is received. This allows in principle to update it more quickly than using system information update. Also, having the cellBarred so early in the process allow a UE to read only MIB and evaluate that the cell is barred and therefore it needs to search for another cell. However, there is a problem to implement further access control on MIB: there is only one spare bit on MIB. We have a very special solution for that giving two meanings for the same bit, namely:
In the first need (e.g. Rel-18) the last MIB bit can be used as an extra barring bit, which solves the immediate NES needs.
Together with that (on Rel-18) or in a later release (e.g. Rel-19) a MIB extension is defined and this bit is used to indicate extension.

In essence the remaining spare bit is reserved for a future extension of MIB, but as a behavior UEs which do not support the extension shall consider the cell barred if the extension is set to true (extension present). This allows to: 1) use the bit as barring bit for Rel-18 and still 2) make sure that future needs can be covered.

There are some different ways to implement that. For example, this field may be called for example cellBarredOrMIBExtension-r18. The MIB field would then be updated to:

-- ASN1START
-- TAG-MIB-START
MIB ::= SEQUENCE {
systemFrameNumber BIT STRING (SIZE (6)),
subCarrierSpacingCommon ENUMERATED {scs15or60, scs30or120},
ssb-SubcarrierOffset INTEGER (0..15),
dmrs-TypeA-Position ENUMERATED {pos2, pos3},
pdcch-ConfigSIB1 PDCCH-ConfigSIB1,
cellBarred ENUMERATED {barred, notBarred},
intraFreqReselection ENUMERATED {allowed, notAllowed},
cellBarredOrMIBExtension-r18 ENUMERATED {barredOrExtension,
notBarredNoExtension },
}
-- TAG-MIB-STOP

The description of the field could be
cellBarredOrMIBExtension-r18
Value barredOrExtension means that the cell is barred, as defined in TS 38.304 if the UE does not support MIB extension and it means the UE has to read the MIB extension if it supports the MIB extension

Alternatively, the field could be simply described as a MIB extension, but the behavior of being barred is added. In that case, the MIB is updated to something like:

-- ASN1START
-- TAG-MIB-START
MIB ::= SEQUENCE {
systemFrameNumber BIT STRING (SIZE (6)),
subCarrierSpacingCommon ENUMERATED {scs15or60, scs30or120},
ssb-SubcarrierOffset INTEGER (0..15),
dmrs-TypeA-Position ENUMERATED {pos2, pos3},
pdcch-ConfigSIB1 PDCCH-ConfigSIB1,
cellBarred ENUMERATED {barred, notBarred},
intraFreqReselection ENUMERATED {allowed, notAllowed},
MIBextension ENUMERATED {present, notPresent}}
-- TAG-MIB-STOP

### MIBextension

Value present means that a MIB extension is present. If the UE does not support MIB extension it shall consider the cell is barred, as defined in TS 38.304.

And yet another possibility is to specify in the first release as a cellBarred-r18 (similar behavior to existing cellBarred by applied for Rel-18 onwards) and later rename it/re-specify as MIBextension.

TS 38.331 v17.3.0 states on section 8.4 “A transmitter compliant with this version of the specification shall set spare bits to zero.”. Therefore, the embodiment is that the value which indicates no MIB extension, and no barring is mapped to zero, whereas the value which indicates MIB extension/barring is mapped to one. This may facilitate new UEs to access older cells without confusion.

Note that the approach on this section may be combined with the other possibilities (section “Independent indication per feature or group of features” or “Feature ID and Feature List” or “Support level indication”). For example, some embodiment based on this section and section “Support level indication” may work as follows: Rel-18 UEs are barred by using cellBarredOrMIBExtension-r18. Rel-19 UEs instead shall read the MIB extension (or SIB-1) to check support levels for Rel-19 onwards.

### UE NES Capability

In order to configure or re-configure the fields according to embodiments/on this invention, the network may need to be/may be informed about what the UE is capable of. One or multiple new UE capabilities could be added to the existing UE capabilities information indicating, whether a UE is supporting NES techniques. The UE capability could e.g. be added as an additional feature set using e.g. a newly introduced IE (information element).

The “NES” UE capability could either indicate.
Full or no support of NES techniques or
An indication (e.g. list or group) of the supported or not supported NES techniques.
RAN release specific indication of the supported NES techniques (e.g. Rel-18 may indicate that all NES techniques considered in the TS in Rel-18 are supported)
Whether the framework of this invention is supported or not.
How quickly the UE can adapt if the added field(s) are changed (e.g because a feature is now activated)

To retrieve this information from the UEs the network typically sends an enquiry e.g. “UECapabilityEnquiry” and the UE responds sending the UE capabilities, e.g. “UECapabilityInformation”.

The network may initiate this enquiry asking for the UE capabilities-specifically for NES when specific conditions are met. One possible condition may apply before the cell determines to apply all or any NES technique, e.g. based on low traffic load (maybe derived from exceeding a threshold indicating the cell load.

The new fields(s) or IDs which control access could also be based on direct matching to UE capability information. As non-limiting examples:
The same information elements used both UE capability and on MIB/SIB to indicate UE capabilities which are currently barred or not.
A mapping between UE capabilities (signaled by UE on “UECapabilityInformation”) and the fields added on MIB/SIB to support this invention

Whenever the UE receives information on specific NES technique(s) applied or not applied on the cell or specific frequency band(s), the UE may match the received NES technique(s) against its UE capabilities to determine, whether to access or not the cell/frequency band of the cell, i.e. to determine whether be barred or not.

Note: for NR UE capabilities see [2].

### Load Balancing

As described in above section when legacy UEs are barred from newer cells, a related problem appears: some severe imbalance on the load, which needs to be flexibly handled over the lifetime of a feature. The optimal network strategy then depends on the share of legacy UEs vs UEs supporting one or more of the new features activated by the cell. As new features (e.g. NES techniques) are implemented over time the share of UEs supporting the new features start at a very low value (e.g. 0.1%) and grows to a very large value (99.9%). The share of legacy UEs decrease over time. In order to give operators full flexibility and control at any share of legacy vs new UEs some mechanisms are needed to control the load.

According to embodiments load balancing may be performed according to one of the below discussed approaches.

### Load Balancing by Reverting Frequency Priority Order

The load balancing may be according to an embodiment managed by reverting the frequency priority order. Basically, if cellBarred is set to barred, the newer barring is set to not barred (e.g. cellBarredOrMIBExtension-r18) and the UE is a new UE (e.g. a NES-aware UE) the UE can calculate a new priority which is the reverse of the existing absolute priority. As an example, if there are 2 frequencies with absolute priority 3 and 5. Legacy UEs will prefer the frequency with priority 5. Now if the network would like to apply NES to the frequency with priority 3, it needs to make sure that NES UEs will come to that frequency. If the conditions apply (e.g. cellBarred as barred, cellBarredOrMIBExtension-r18 as not barred), the newer UEs may consider the reverse priority order, i.e. 3 is higher priority than 5. Currently 0 is the lowest absolute priority and 7 is the highest. So, by reversing the priority order, it would mean to have 7 as the lowest priority and 0 as the highest. Note that cells which do not have cellBarred as “barred” are not into NES mode and therefore not trying to block legacy UEs. There normal priority rules can apply.

### Load balancing by applying a priority offset

Similar to the approach just described, another possibility according to another embodiment is to use a priority offset for NES UEs. For example if the conditions apply (e.g. cellBarred as barred, cellBarredOrMIBExtension-r18 as not barred), the UE shall sum a certain number (e.g. 7) to the absolute priority. In the previous example, this would make a NES cell have priority 10 for NES UEs and priority 3 for legacy UEs while the non-NES cell would have priority 5.

### Load Balancing by Using a Cell Magnet

The approach on sections “Load balancing by reverting frequency priority order” and “Load balancing by applying a priority offset” lack the flexibility to change the priority over time, for example when there are still legacy UEs but most UEs are NES capable UEs. This can be overcome by introducing a “cell magnet” bit which indicates whether this cell is preferred by new UEs according to embodiments. The new UEs are attracted to this cell (like a magnet attracts metals).

### Load Balancing by Using IDs

Whenever the cell starts barring some UEs, there is a chance that the group of the UEs which are barred are large and may cause load imbalance. The idea of assigning an ID to each feature can help the load balancing issue according to further embodiments. As an example, whenever the number of legacy UEs are high in an area, and one cell enters the NES state and starts to bar all the legacy UEs, the number of legacy cells will increase leading to unbalanced load on the cells. To solve this issue, the UEs should prioritise the cell which is using the NES method supported by the UE to camp on. This selection can be done by comparing the IDs of the techniques the UE is supporting and the IDs that the cell is supporting and prioritizing the cells where there is a higher number of matches and deprioritizing the cells where there is lower number of matches or no matches. A match may mean match between features supported by UE and the cell.

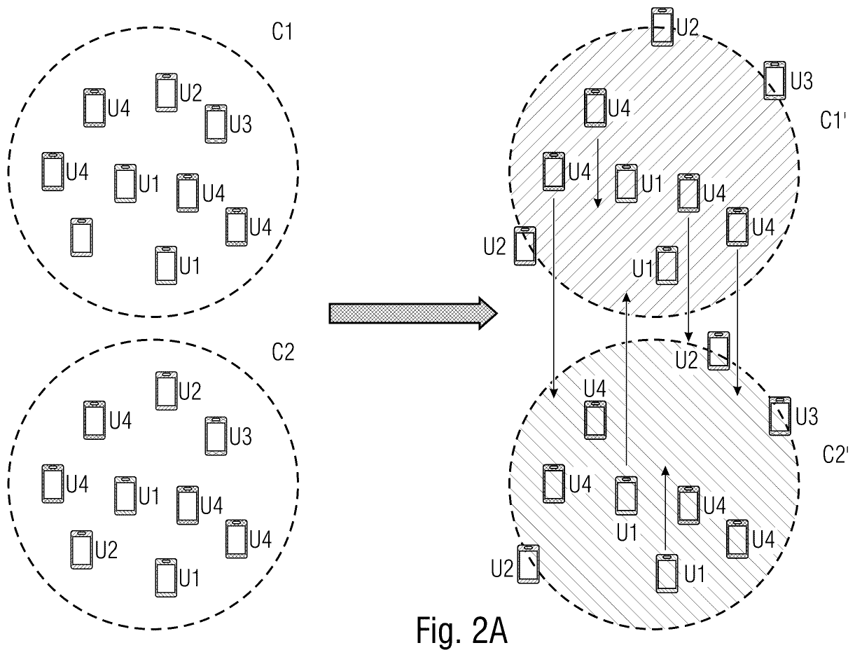

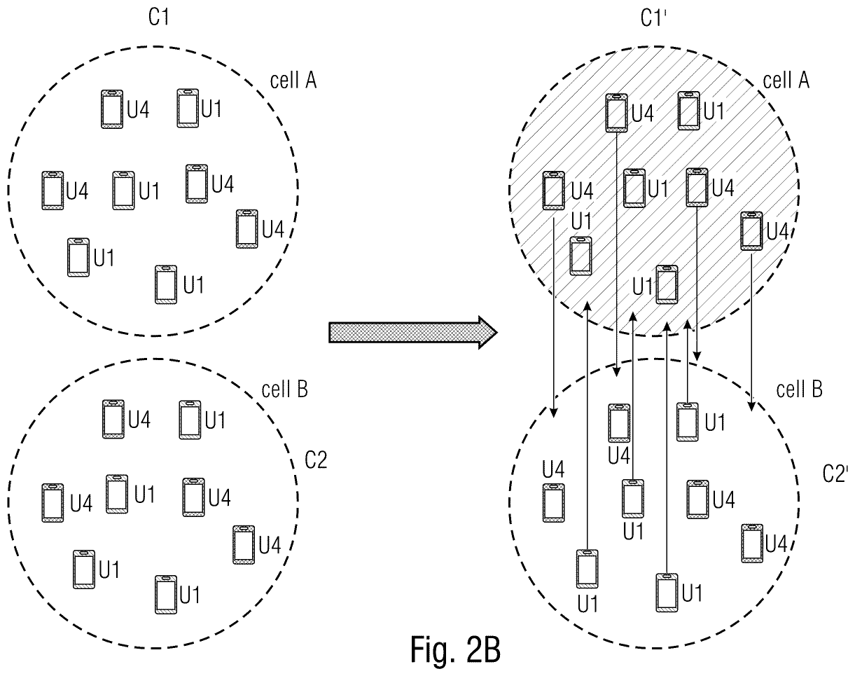

FIG. 2a shows two cells C1 and C2 before two types of NES UE grouping is enabled. As can be seen, the UEs supporting different techniques marked by UE1, UE2, UE3 and UE4 are randomly arranged in the two cells C1 and C2. After applying the NES technique a kind of access support is performed so that UEs not supporting a technique, e.g., UE1 in cell C2, changes the cell from C2 to C1′. Vice versa, the UEs U4 previously arranged in cell C1 gets access to cell C2′ after applying the NES technique. The reselection of the cells is illustrated by the arrow between the NES applying cells C1′ and C2′. The background for the reselection is, on the one hand, that a UE, e.g., U1, has no access anymore to C2′ or, on the other hand, that some UEs, e.g., the UE U4, are attracted to the cell C2′. In other words, this means that when one of the cells C1′ or C2′ apply a NES technique, the UEs supporting the technique, e.g., UE U4, may reselect the cell C2′ and the UEs, e.g., UE1, not supporting the technique may reselect another cell C1′.

FIG. 2b illustrates principally the same but just with the UEs U1 and U4. Before applying the technique (cf. cell C1 and C2) the UEs U1 and U2 are mixed within the cells C1 and C2. After applying the cells (see right-hand side) the UEs U4 reselect cell C2′, when they are in a cell C1′, while the UEs U1 reselect the cell C1′ when they are in the cell U2′. The other UEs U1 and U2, which are in the cell supporting the supported technique or enabled technique, stay in the respective cells C1′ and C2′.

As depicted in the FIGS. 2a and 2b, as an example whenever there are two types of NES UE groups one supporting technique number 1 and the other supporting technique number 4 (recall from FIG. 1) there are a couple of ways to help the load balancing:
As soon as one or both cells enter the NES mode, the UEs which are supporting the technique can still camp on the same cell and the barred UEs can reselect the nearest cell supporting the technique they support.
The reselection can happen sooner and gradually. Instead of the sudden change to NES state, the cell can inform the UEs with broadcasting the list of techniqueIDs some time beforehand. Then the UEs who are not supporting the technique can either reselect the cells which are supporting their respective NES technique, or the cells which are not in NES mode, to camp on them.

### Load Balancing by Signaling Between Cells

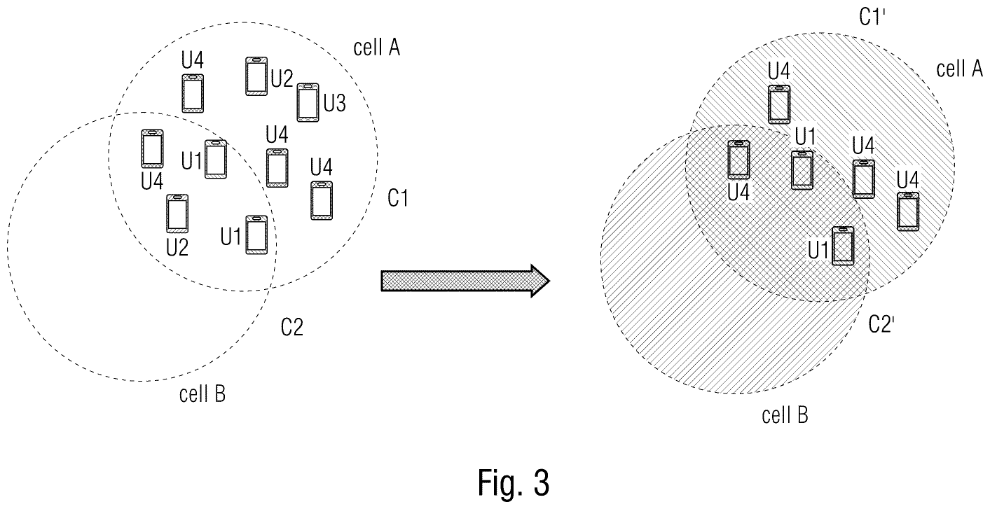

Another option for load balancing according to an embodiment would be signaling of the base stations. In this case cells instead of broadcasting the ID of the features that they support and will apply, to the UEs, they will send it to the other cells. In this case, the cells can decide on the features that it will be using. For example, in case the two neighboring cells enter the NES mode, where both are supporting the technique 1 and 2, the signaling prevents them both from choosing the same technique, as depicted in FIG. 3. FIG. 3 shows on the left-hand side the two cells C1 and C2 before applying the technique and on the right-hand side the cell C1′ and C2′ after applying the technique. As can be seen, the cells C1 and C2 as well as C1′ and C2′ are cells and have an overlap.

After applying the respective NES technique or NES mode, only the UEs U1 and U4 have access to the cells C1′ and C2′. Furthermore, according to embodiments, it might make sense that the two cells C1′ and C2′, which principally indicate that the techniques of the UEs U1 and U4 are supported, can reorganize the access conditions, so that all UEs U4 belong cell C1′, while all UEs U1 only have access to the cells C2′.

This is done within the overlapping region and/or by overlapping cells.

If the two neighboring cells, choose different techniques they will give an opportunity to the UEs to reselect the other cell in case they technique match. Inevitably, the UEs not supporting any of these techniques would have to check for further options.

### Load Balancing Based on Number/Percentage of UEs Supporting NES

Another approach helping the load balancing-according to an embodiment-is choosing the features based on the number (e.g. majority) or percentage of the UEs supporting that feature on a cell.

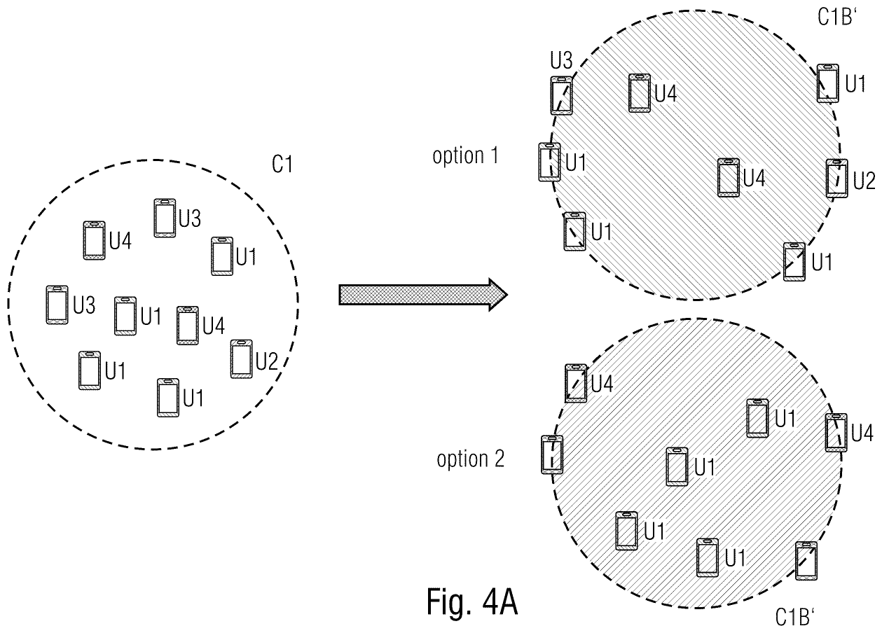

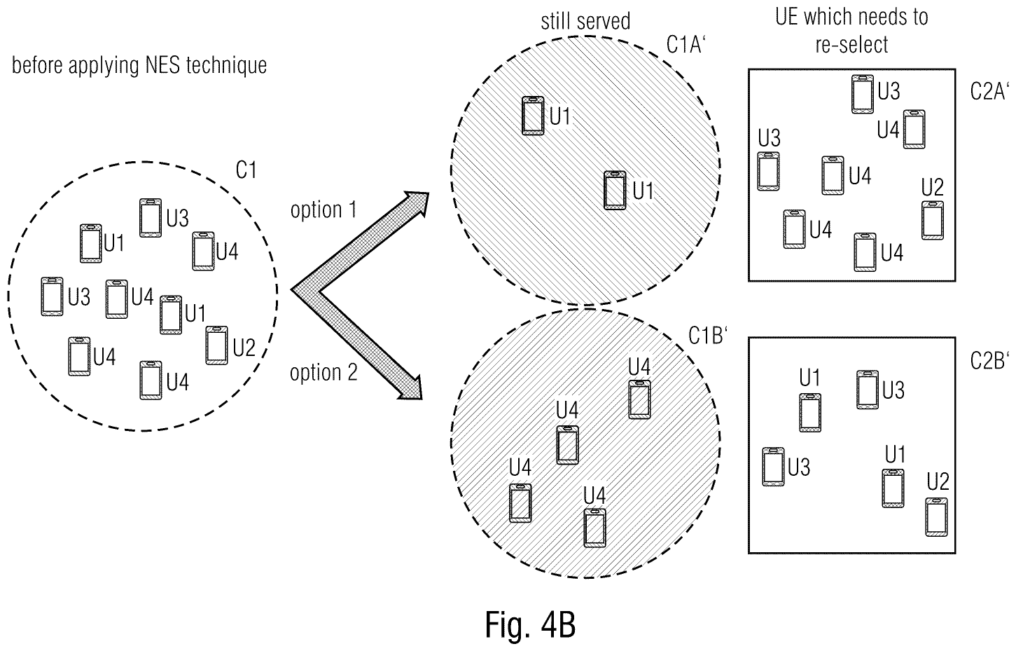

As shown in the FIGS. 4a and 4b, if the cell both supports technique 1 and 4, it would be the most efficient option to choose the technique 1, if the majority of the UEs are supporting this technique. In this case a prior knowledge for the cell is used.

FIGS. 4a and 4b illustrate two possibilities as to what happens when technique one is formed, i.e., the technique supported by UE UE1 and UE4 are used to perform selection. According to the approach of FIG. 4a the UEs UE1 to UE4 of cell C1 can be forced to reselect. According to option 1 only the access of the UEs U4 is allowed, wherein according to option 2 only the access of the UEs U1 is allowed.

This means, as illustrated in FIG. 4b, that UE1 is still served according to option 2 and UE4 is still served according to option 2. For example, it might be possible that two options are provided, namely option C1A′ and option C1B′, where option C1A′ supports the UEs U1 and the option C1B′ supports the UEs U4. The cell will chose the preferred option. The other UEs from the respective cells are forced to reselect another cell as illustrated in FIG. 4b (C2A′ and C2B′).

According to embodiments, there are several options to find out the NES techniques supported by the UEs on the cell. Example are listed below:
1. Obtain the number/percentage of UE supporting (all or some) NES techniques by the cell by polling. If the cell can support more than a NES technique, it can ask the UEs to clarify the techniques that they support and choose the technique which is supported by the majority of UEs. This will let the majority of the UEs to stay and camp on the cell and the minority to be barred and moved to other cells to camp on them.
2. Derive/calculate the number/percentage of UE supporting (all or some) NES techniques from the UE capabilities indicating whether all or some NES techniques are supported. See also section “UE NES Capability”,

To derive the (specific) UE capabilities related to NES, the network may retrieve this information from the UEs by sending an enquiry e.g. “UECapabilityEnquiry” maybe limited to NES, where the UE responds with the needed UE capabilities, e.g using a “UECapabilityInformation”.

### General

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments, the user device, UE, described herein may be one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, or a mobile terminal, or a stationary terminal, or a cellular IoT-UE, or a vehicular UE, or a vehicular group leader, GL, UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

The base station, BS, described herein may be implemented as mobile or immobile base station and may be one or more of a macro cell base station, or a small cell base station, or a central unit of a base station, or a distributed unit of a base station, or an Integrated Access and Backhaul, IAB, node, or a road side unit, or a UE, or a group leader, GL, or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

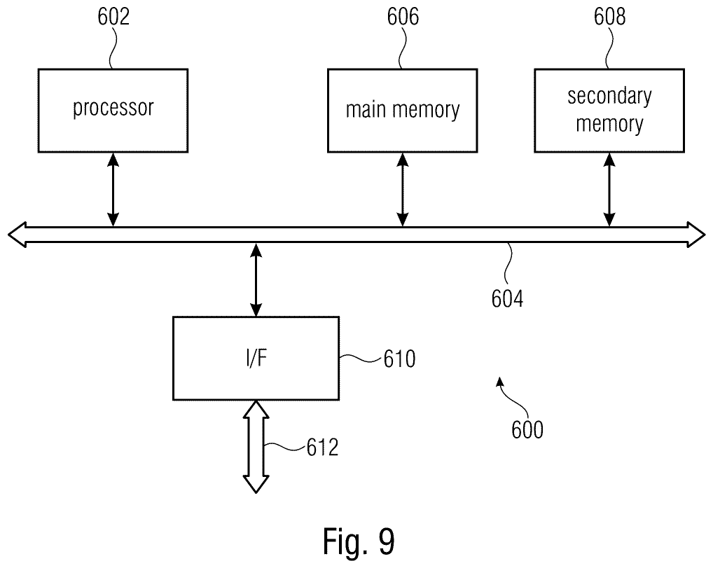

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 9 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier, or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

REFERENCES

| Ref. | Details |
|---|---|
| 1 | TR 38.864 Study on network energy savings for NR (Release 18), V18.0.0, |
| | 2022 December |
| 2 | TS 38.306 User Equipment (UE) radio access capabilities (3GPP TS 36.306 |
| | version 17.3.0 Release 17) |
| 3 | R2-2212116, Cell (re)selection for handling legacy UEs and NES capable |
| | UEs, Intel Corperation |
| 4 | R2-2211681, Further discussion on cell (re)selection enhancement for |
| | Network energy saving, Apple |
| 5 | RP-223540, New WID: Network energy savings for NR, 3GPP TSG RAN |
| | Meeting #98-e, Dec. 12-16, 2022 |
| 6 | R2-2211666, Discussion on cell selection/reselection, VIVO, 3GPP TSG- |
| | RAN WG2 Meeting #120, Toulouse, FR, 14th-18th Nov. 2022 |
| 7 | TS 38.331 V17.3.0, Radio Resource Control (RRC) protocol specification |
| | (Release 17) |
| 8 | TS 38.304 V17.3.0, User Equipment (UE) procedures in Idle mode and RR |
| | Inactive state (Release 17) |

ABBREVIATIONS

| Abb. | Meaning |
|---|---|
| NES | Network Energy Saving |
| NPN | Non-Public Network |
| gNB | Next generation node B |
| NR | New Radio |
| UE | User equipment |
| MIB | Master information block |
| SIB | System information block |

1. First transceiver, e.g. a transceiver of a user equipment, UE configured to receive a signal comprising one or more enhanced fields carrying an information for access control based upon feature support of one or more features or feature activation of one or more features, and
wherein the first transceiver is configured to control its own access to a cell dependent on the one or more enhanced fields;
wherein the information for access control is carried by master information block, MIB, or system information block, SIB;
wherein if the one or more features are not supported or de-activated by the UE, the transceiver considers the cell as barred;
wherein the one or more features comprise Network Energy Saving, NES, feature or Network Energy Saving, NES, capability;
wherein the transceiver is configured to transmit in response to one or more enhanced fields including an information on NES capability or a request an information element indicating a NES capability.

2. First transceiver according to claim 1, wherein the one or more enhanced fields are included in at least one of the following:
on MIB.
on SIB-1.

3. (canceled)

4. First transceiver according to claim 1, wherein the enhanced fields comprise; or wherein the enhanced fields are defined as 1 bit per feature; or wherein the more enhanced fields correspond to UE capabilities.

5. First transceiver according to claim 1, wherein the one or more enhanced fields indicate one or more features as barring features where if the feature is not supported by the UE, the UE shall consider the cell as barred, or as implying de-prioritization features where if the feature is not supported by the UE, the cell shall be considered with low priority for access.

6-7. (canceled)

8. First transceiver according to claim 1, wherein the information element is transmitted using said one or more enhanced fields or as a mapping between UE capabilities and said one or more enhanced fields.

9. First transceiver according to claim 1, wherein the information element comprises one of:
Full or no support of NES techniques; or
An indication of the supported or not supported NES techniques;
RAN release specific indication of the supported NES techniques;
whether the framework is supported or not;
how quickly the UE can adapt if the added field(s) are changed; and/or
wherein the transceiver is configured to use neighboring cell if cell is barred; or
wherein the transceiver is configured to reselect a cell is barred as response to a list of IDs of the features supported by the cell; and/or
wherein the transceiver is configured to receive an extension bit, like MIB extension, and if the UE does not support the extension shall consider the cell as barred.

10-15. (canceled)

16. Second transceiver, e.g. a transceiver of a base station, BS, being configured to transmit a signal within a cell, the signal comprising one or more enhanced fields carrying an information for access control based upon feature support of one or more features or feature activation of one or more features, and
wherein the second transceiver is configured to control access to the cell dependent on the one or more enhanced fields;
wherein the information for access control is carried by master information block, MIB, or system information block, SIB;
wherein if the one or more feature are not supported or de-activated by the UE, the transceiver considers the cell as barred;
wherein the one or more feature comprise Network Energy Saving, NES, feature or Network Energy Saving, NES, capability;
wherein the transceiver is configured to transmit in response to one or more enhanced fields including an information on NES capability or a request an information element indicating NES capability.

17. Second transceiver according to claim 16, wherein an information for access control is carried by one or more of the following:
system information block, SIB, for example SIB-1 or any other SIB;
master information block, MIB, or master information block, MIB, comprising an extension or the one or more enhanced fields;
any other option;
Wifi beacon;
as to any combination of the above options or any other kind of signaling.

18. (canceled)

19. Second transceiver according to claim 16, wherein the one or more enhanced fields indicate one or more features to be supported by the UE to access the cell or implying barring or features which imply de-prioritization.

20-22. (canceled)

23. Second transceiver according to claim 16, wherein the one or more enhanced fields carrying an information on one of the following:
One or more features used e.g. feature ID, feature list, any other form to NES technique; or
UE capability (requirements);
UE capability mapped to a feature ID; or
RAN release/support level; and/or
wherein the signal is sent using PBSCH; and/or
wherein the at least one field is the last MIB bit used as first part for access control; or
wherein the one or more enhanced fields are used as second part.

24-33. (canceled)

34. UE comprising a second transceiver according to claim 16 wherein the second transceiver is configured to prefer a cell if a number of features supported by the UE is high and to deprioritize a cell where the number of features supported by the UE is low; or
to reselect a cell is barred as response to a list of features or IDs of the features supported by the cell.

35. BS or network control comprising a first transceiver according to claim 1 and being further configured for load balancing within a cell, being configured for:
supporting load balancing by broadcasting a list of IDs of the features supported by the cell so as to force the UE to reselect if one or more features are not supported; or
supporting load balancing by broadcasting respective IDs of the features to be supported by the UE or of the features supported by the cell so that the UE is enabled to prioritize cells where there is a higher number of matches and deprioritize cells where there is lower number of matches or no matches; or
performing load balancing in a network where different priorities are assigned to different frequencies, especially absolute priority 3 and 5 and wherein load balancing is managed by reverting the frequency priority order; or
performing load balancing in a network having at least one cell wherein load balancing is performed by transmitting a cell magnet bit which indicates whether this cell is preferred by new UEs or UEs having certain feature capability; or
performing load balancing in a cell by choosing features to be supported based on a number or percentage of the UEs in said cell supporting said features; or
performing load balancing in a cell by choosing features to be supported based on a number or percentage of the UEs in said cell supporting said features, wherein the number or the percentage is determined by the cell by polling or based on receipt of information element indicating UE capabilities; or
performing load balancing by coordinating features to be supported by neighboring cells.

36. Method for operating a second transceiver comprising:
transmitting a signal within a cell, the signal comprising one or more enhanced fields carrying an information for access control based upon feature support of one or more features or feature activation of one or more features, and
controlling access to the cell dependent on the one or more enhanced fields;
wherein the information for access control is carried by master information block, MIB, or system information block, SIB;
wherein if the one or more feature are not supported or de-activated by the UE, the transceiver considers the cell as barred;
wherein the one or more feature comprise Network Energy Saving, NES, feature or Network Energy Saving, NES, capability;
wherein the transceiver is configured to transmit in response to one or more enhanced fields including an information on NES capability or a request an information element indicating NES capability.

37. Method for operating first transceiver comprising:
receiving a signal comprising one or more enhanced fields carrying an information for access control based upon feature support of one or more features or feature activation of one or more features, and
controlling its own access to a cell dependent on the one or more enhanced fields;
wherein the information for access control is carried by master information block, MIB, or system information block, SIB;
wherein if the one or more feature are not supported or de-activated by the UE, the transceiver considers the cell as barred;
wherein the one or more feature comprise Network Energy Saving, NES, feature or Network Energy Saving, NES, capability;
wherein the transceiver is configured to transmit in response to one or more enhanced fields including an information on NES capability or a request an information element indicating NES capability.

38-39. (canceled)

40. A non-transitory digital storage medium having a computer program stored thereon to perform the method of claim 36 or a method for operating first transceiver comprising: receiving a signal comprising one or more enhanced fields carrying an information for access control based upon feature support of one or more features or feature activation of one or more features, when said computer program is run by a computer.
